(19) United States
(12) Patent Application Publication
(10) Pub. No.: US 2019/0310458 A1
(43) Pub. Date: Oct. 10, 2019

(54) MIRROR DRIVE DEVICE AND IMAGE PICKUP APPARATUS USING THIS

(71) Applicant: CANON KABUSHIKI KAISHA, Tokyo (JP)

(72) Inventors: Keisuke Fukuyo, Beppu-shi (JP); Hiroaki Inukai, Kawasaki-shi (JP)

(21) Appl. No.: 16/371,500

(22) Filed: Apr. 1, 2019

(30) Foreign Application Priority Data
Apr. 4, 2018 (JP) 2018-072583

(51) Int. Cl. G02B 26/08; G02B 7/182

(52) U.S. Cl. CPC G02B 26/0816; G02B 7/1821

(57) ABSTRACT

A mirror drive device that is capable of achieving high speed drive of a mirror unit and of reducing generation of bounds of mirrors. A first mirror unit is rotatably attached to a mirror box and is movable between a fast position within a photographing light path and a second position outside the path. A second mirror unit is rotatably attached to the first mirror unit and is movable between a third position within the path and a fourth position outside the path. A drive member moves the first mirror unit to the second position from the first position and moves the second mirror unit to the fourth position from the third position when, the drive member is driven by an actuator to a sixth position from a fifth position.

### BACKGROUND OF THE INVENTION

### Field of the Invention

The present invention relates to a mirror drive device and an image pickup apparatus using this.

### Description of the Related Art

A quick return mirror mechanism of a single-lens reflex camera moves a mirror unit that has a main mirror and a sub mirror at a high speed between a mirror-down state in which the mirror unit enters into a photogiaphing light path and a mirror-up state in which the mirror unit is retracted from the photographing light path. The mirrors of the mirror unit are positioned at predetermined stop positions because the mirror unit contacts a stopper provided in a mirror box in the mirror-down state, and guide an object light flux passing through a photographing optical system of a lens unit to a finder optical system and a focus detection sensor unit.

In view of improvement of continuous photographing performance, a technique for stably keeping the main mirror and sub mirror in the mirror-down state promptly by reducing bounds of the mirrors that occur when the mirror unit that is rapidly driven toward the mirror-down state contacts the stopper is continuously required. A conventional mirror drive device drives the mirror unit between the mirror-down state and the mirror-up state by transmitting power to the main mirror and by making the sub mirror follow a motion of the main mirror using a combination of a toggle spring and a reversal cam or a linkage mechanism. Accordingly a technique that reduces the bound of the main mirror by attenuating the amount of motion of the main mirror during the mirror-down action is proposed (for example, see Japanese Laid-Open Patent Publication (Kokai) No. 2015-40891 (JP 2015-40891A)).

However, in the technique disclosed in the above-mentioned publication, since the sub mirror, is driven by following the main mirror, it is difficult to control the action of the sub mirror during driving, and according, there is a problem that the bound of the sub mirror cannot be reduced.

### SUMMARY OF THE INVENTION

The present invention provides a mirror drive device and an image pickup apparatus using this that are capable of achieving high speed drive of a mirror unit and are capable of reducing generation of bounds of a main mirror an sub mirror.

Accordingly, a first aspect of the present invention provides a mirror drive device including a first mirror unit that is rotatable attached to a mirror box and is movable between a first position within a photographing light path and a second position that is retracted from the photographing light path, a second mirror unit that is rotatably attached to the first mirror unit and is movable between a third position within the photographing light path and a fourth position that is retracted from, the photographing light path, and a drive member that is driven by an actuator so as to be movable between a fifth position and a sixth position. The drive member moves the first mirror unit to the second position from the first position and moves the second mirror unit to the fourth position from the third position when the drive member moves to the sixth position from the fifth position. The drive member moves the first mirror unit to the first position from the second position and moves the second mirror unit to the third position from the fourth position when the drive member moves to the fifth position from the sixth position.

Accordingly, a second aspect of the present invention provides an image pickup apparatus including a mirror box, and the mirror drive device of the first aspect.

According to the present invention, the high-speed drive of the mirror unit is available, and the generation of the bounds of the main mirror and sub mirror is reduced.

Further features of the present invention will become apparent from the following description of exemplary embodiments with reference to the attached drawings.

### BRIEF DESCRIPTION OF THE DRAWINGS

FIG. 1 is a block diagram schematically showing a system configuration of an image pickup apparatus of the present imvention.

FIG. 2A and FIG. 2B are schematic sectional views of the image pickup apparatus.

FIG. 3 is an exploded perspective view of the mirror drive device according to a first embodiment.

FIG. 4 is a view for describing relation between a mirror drive unit and a drive lever unit of the mirror drive device shown in FIG. 3.

FIG. 5 is a view for describing a condition of the mirror drive unit in a mirror-down state.

FIG. 6A and FIG. 6B are views for describing conditions of the mirror drive unit during a mirror-up action.

FIG. 7 is a view for describing a condition of the mirror drive unit in a mirror-up state.

FIG. 8A and FIG. 8B are views for describing conditions of the mirror drive unit during a mirror-down action.

FIG. 9A and FIG. 9B are views for describing a configuration of a mirror drive unit according a second embodiment.

FIG. 10 is a view for describing a configuration of a mirror drive unit according to a third embodiment.

FIG. 11 is a view for describing a configuration of a mirror drive unit according to a fourth embodiment.

FIG. 12A, FIG. 12B, and FIG. 12C are views for describing a condition of a mirror drive unit according to a fifth embodiment in the mirror-down state.

FIG, 13A, FIG. 13B, and FIG. 13C are views for describing a condition of the mirror drive unit according to the fifth embodiment in the mirror-up state.

FIG. 14A, FIG. 14B, and FIG. 14C are views for describing a condition of the mirror drive unit according to the fifth embodiment during driving.

### DESCRIPTION OF THE EMBODIMENTS

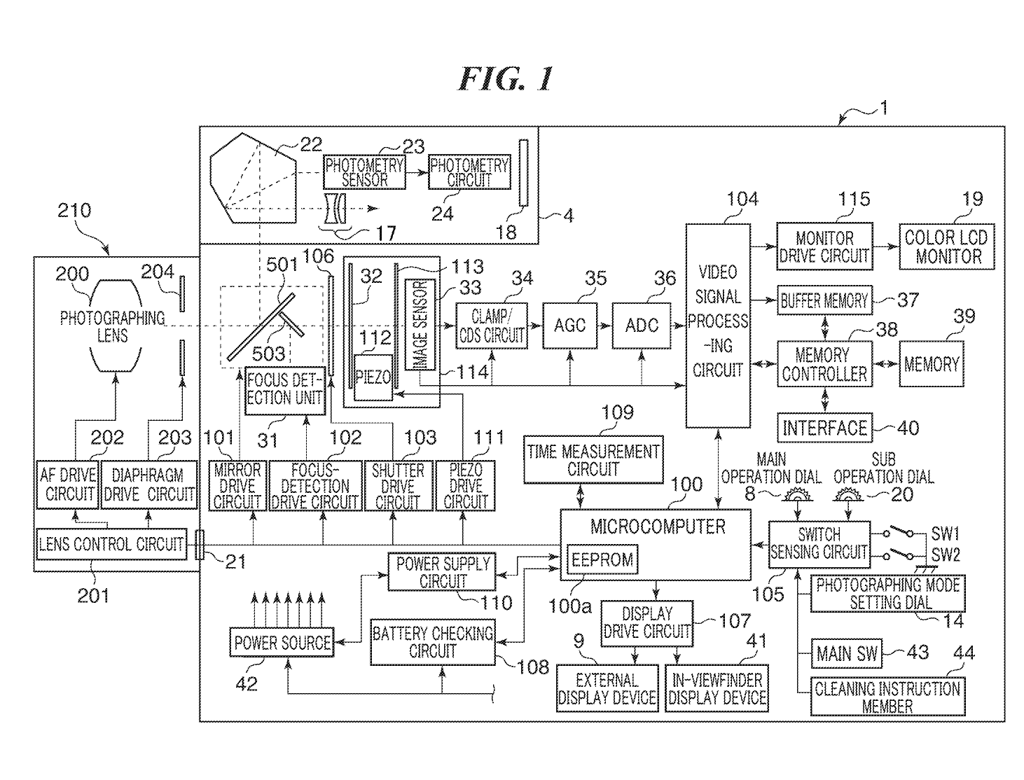

Hereafter, embodiments according to the present invention will be described in detail by referring to the drawings. FIG. 1 is a block diagram showing a system configuration of an image pickup apparatus equipped with a mirror drive device of the present invention. The image pickup apparatus shown in FIG. 1 is a digital single lens reflex camera specifically, and has an image pickup apparatus body 1 and an interchangeable lens unit 210 that is attachable to and detachable from a mount contact portion 21 provided in the image pickup apparatus body 1.

The image pickup apparatus body 1 is provided with a microcomputer 100 (hereinafter referred to as an “MPU 100”). The MPU 100 includes an EEPROM 100a. The EEPROM 100a stores time information and a control program of a time measurement circuit 109 and other information. The MPU 100 controls actions of the entire image pickup apparatus by running a predetermined program stored in the EEPROM 100a. A mirror drive circuit 101, focus detection drive circuit 102, shutter drive circuit 103, video signal processing circuit 104, switch sensing circuit 105, and display drive circuit 107 are connected to the MPU 100. The MPU 100 controls an action of each of these circuits. Moreover, a battery checking circuit 108, the time measurement circuit 109, a power supply circuit 110, and a piezoelectric-element drive circuit 111 are connected to the MPU 100. The MPU 100 controls an action of each of these circuits.

The image pickup apparatus body 1 is provided with a main mirror 501, a sub mirror 503, a focus detection unit 31, a finder optical system 4, a focal-plane shutter 106, and an image-pickup-device unit 114. The finder optical system 4 includes a pentagonal prism 22, an eyepiece optical system 17, a finder eyepiece window 18. a photometry sensor 23, and a photometry circuit 24. The image-pickup-device unit 114 includes an image pickup device 33, a laminated piezoelectric device 112, an optical low-pass filter 32, and an infrared cut filter 113.

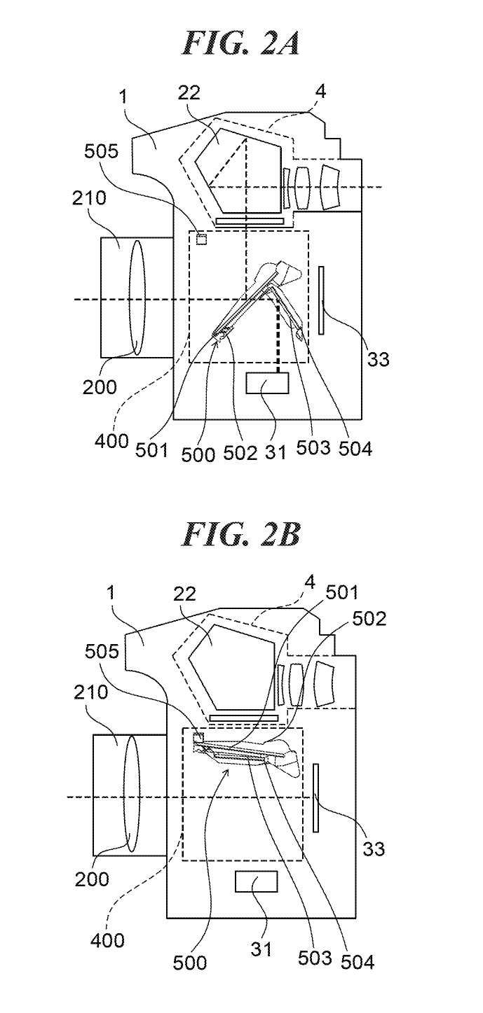

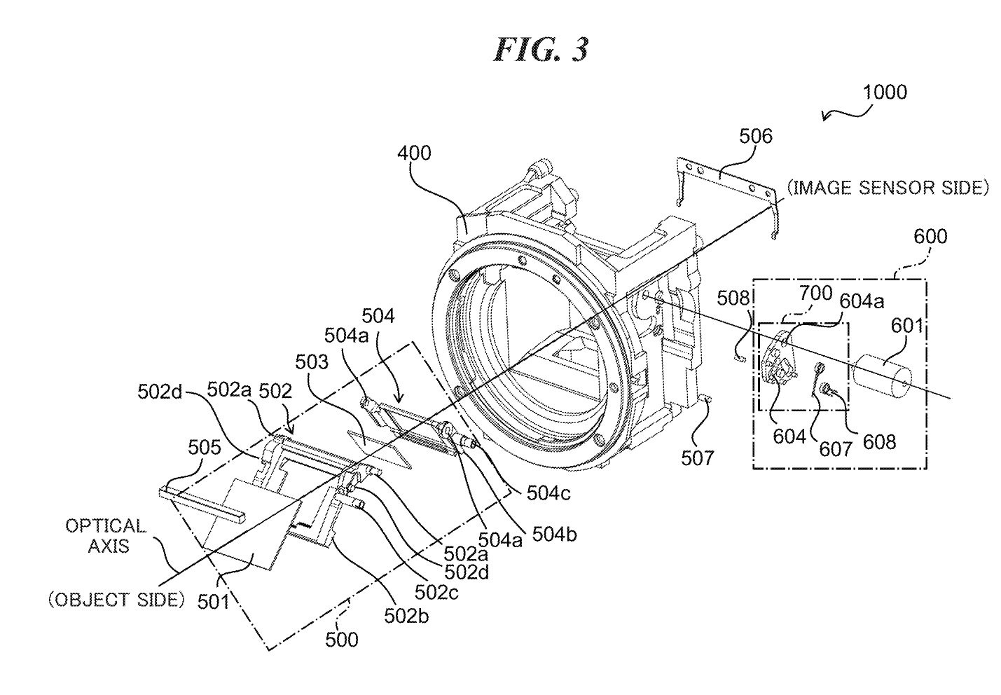

The main mirror 501 and the sub mirror 503 are movable between a mirror-up state (see FIG. 2B) in which the mirrors are retracted from a photographing light path and a mirror-down state (see FIG. 2A) in which the mirrors enter into the photographing light path. The main mirror 501 is constituted by a half mirror. In the mirror-down state, the main mirror 501 reflects an object light beam passing through the lens unit 210 to guide it to the finder optical system 4 and transmits a part of the object light beam to guide it to the sub mirror 503. The sub mirror 503 reflects the object light beam that transmitted the main mirror 501 to guide it to the focus detection unit 31. When the main mirror 501 and the sub mirror 503 are in the mirror-up state, the object light beam passing through the lens unit 210 forms an image on the image pickup device 33. The mirror drive circuit 101 rotates the main mirror 501 and the sub mirror 503 between the mirror-up state and the mirror-down state by controlling driving of a motor 601 (see FIG. 3) while detecting positions of the main mirror 501 and the sub mirror 503.

The focus detection unit 31 consists of a line sensor that consists of a plurality of CCD sensors, a field lens arranged near an image plane, a reflective mirror, a secondary image forming lens, a diaphragm, etc. A signal output from the focus detection unit 31 is supplied to the focus detection drive circuit 102, is converted into an image signal of an object, and then is sent to the MPU 100. The MPU 100 calculates a defocus amount and a defocus direction by performing a focus detection calculation by a phase difference detection method based on the supplied image signal. The MPU 100 drives a focusing lens of a photographing lens 200 in the lens unit 210 to an in-focus position through a lens control circuit 201 and an AF drive circuit 202 provided in the lens unit 210 on the basis of the calculation result.

In the finder optical system 4, the pentagonal prism 22 reflects the object light beam reflected by the main mirror 501 in the mirror-down state while converting into an erected normal image. A user is able to observe the erected normal image converted as an object image from the finder eyepiece window 18 through the tinder optical system 4 and the eyepiece optical system 17. Moreover, the pentagonal prism 22 guides a part of the object light beam to the photometry sensor 23, and an output of the photometry sensor 23 is supplied to the photometry circuit 24. The photometry circuit 24 converts the output from the photometry sensor 23 into a luminance signal of each area on an observation screen and outputs it, to the MPU 100. The MPU 100 calculates an exposure value on the basis of the luminance signal output from the photometry circuit 24.

The focal-plane shutter 106 is controlled by the shutter driving circuit 103 according to an instruction from the MPU 100. The focal-plane shutter 106 shields the object light beam directed to the image pickup device 33 at the time of finder observation and operates so as to obtain desired exposure time by controlling running time difference between a first blade group and a second blade group (not shown) in response to a release signal at the time of photographing.

In the image-pickup-device unit 114, the optical low-pass filter 32 is a birefringent plate made from crystal and its surface is covered with a conductive substance in order to prevent adhesion of a foreign substance. When receiving an instruction from the MPU 100, the piezoelectric-element drive circuit 111 drives the laminated piezoelectric device 112 so as to vibrate the optical low-pass filter 32 in order to remove a foreign substance on the surface of the optical low-pass filter 32. The infrared cut filter 113 removes unnecessary infrared light from the object light beam. The image pickup device 33 employs a CCD sensor, CMOS sensor, or CID sensor.

The image pickup apparatus body 1 is provided with a clamp/CDS (correlated double sampling) circuit 34, an AGC (automatic gain controller) 35, an A/D converter 36, a video signal processing circuit 104, a monitor drive circuit 115, and a color LCD monitor 19. Moreover, the image pickup apparatus body 1 is provided with a buffer memory 37, a memory controller 38, a memory 39, and an external interface 40.

The clamp/CDS circuit 34 reads a signal (electric charge) from the image pickup device 33 by the correlated double sampling, performs a fundamental analog process before an A/D conversion, and changes a clamp level. The AGC 35 also performs the fundamental analog process before the A/D conversion and changes an AGC basic level. The A/D converter 36 converts an analog signal output from the image pickup device 33 into a digital signal. The video signal processing circuit 104 applies hardware image processes, such as a gamma/knee process, a filtering process and an information composing process for monitor display, to the digital signal (image data) output from the A/D converter 36. The color image data for monitor displays output from the video signal processing circuit 104 is displayed on the color LCD monitor 19 through the monitor drive circuit 115. Moreover, the video signal processing circuit 104 saves the image data into the buffer memory 37 through the memory controller 38 according to an instruction from the MPU 100. Furthemore, the video signal processing circuit 104 has a function to perform an image data compression process like JPEG.

When continuous photographing is performed, the video signal processing circuit 104 once stores the image data into the buffer memory 37 and reads unprocessed image data sequentially through the memory controller 38. Thereby, the video signal processing circuit 104 becomes possible to perform the image process and the compression process irrespective of an output speed of the image data from the A/D converter 36. The memory controller 38 has a function to store the image data output from the external interface 40 like a USB output connector into the memory 39 and to output the image data stored in the memory 39 to the external interface 40. For example, the memory 39 is a flash memory that is detachable from and attachable to the image pickup apparatus body 1.

The image pickup apparatus body 1 is provided with a photometry switch SW1 and a release switch SW2. When a release button provided in the image pickup apparatus body 1 is half pressed, the photometry switch SW1 turns ON and sends an operation signal to start a photographing preparation to the MPU 100 through the switch sensing circuit 105. When the release button is fully pressed, the release switch SW2 turns ON and sends an operation signal to start photographing to the MPU 100 through the switch sensing circuit 105. Moreover, the switch sensing circuit 105 sends operation signals to the MPU 100 depending on operation states of a main operation dial 8, sub operation dial 20, photographing mode setting dial 14, main switch 43, and cleaning instruction member 44 provided in the image pickup apparatus body 1.

The display drive circuit 107 drives an external display device 9 and in-viewfinder display device 41 according to instructions from the MPU 100. The battery checking circuit 108 checks a battery in a predetermined period according to an instruction from the MPU 100 and send a checked result to the MPU 100. A power source unit 42 supplies electric power required for each part of the image pickup apparatus according to an instruction from the MPU 100 through the power supply circuit 110. The time measurement circuit 109 measures time and date until the main switch 43 is turned ON after it was turned OFF and sends a measuring result to the MPU 100 according to an instruction from the MPU 100.

The lens unit 210 is attached to and is detached from the image pickup apparatus body 1 by coupling and releasing the mounts provided in both of them. The lens unit 210 is provided with the photographing lens 200, the lens control circuit 201, the AF drive circuit 202, a diaphragm drive circuit 203, and a diaphragm 204. The lens control circuit 201 communicates with the MPU 100 in the image pickup apparatus body 1 through the mount contact portion 21. The mount contact portion 21 has a function to send a signal to the MPU 100 when the lens unit 210 is connected to the image pickup apparatus body 1. Thereby, the lens control circuit 201 communicates with the MPU 100, drives the photographing lens 200 through the AF drive circuit 202, and drives the diaphragm 204 through the diaphragm drive circuit 203.

Although the photographing lens 200 is actually constituted by a plurality of lens groups, such as a focusing lens, a zoom lens, and an image stabilization lens, it is simplified and shown in FIG. 1. The AF drive circuit 202 has a driving source, such as a stepping motor or a vibration motor, and performs focusing operation to an object by changing the position of the focusing lens in the optical axis direction under control of the lens control circuit 201. The diaphragm drive circuit 203 has an auto iris etc., and obtains an optical aperture value by changing the. aperture diameter of the diaphragm 204 under the control of the lens control circuit 201.

Next, a first embodiment of the present invention will be described. FIG. 2A is a schematic sectional view of the image pickup apparatus in a case where the main mirror 501 and the sub mirror 503 are in the mirror-down state. FIG. 2B is a schematic sectional view of the image pickup apparatus in a case where the main mirror 501 and the sub mirror 503 are in the mirror-up state. The main mirror 501 is held by a main-mirror holder 502, and the sub mirror 503 is held by a sub-mirror holder 504. The main-mirror holder 502 is rotatably supported by a mirror box 400 (see FIG. 3), and the sub-mirror holder 504 is supported so as to be rotatable with respect to the main-mirror holder 502.

In the following description, the main-mirror holder 502 shall always hold the main mirror 501, and the sub-inirror holder 504 shall always hold the sub mirror 503. Accordingly, the position of the main mirror 501 is indicated by the position of the main-mirror holder 502, and the position of the sub mirror 503 is indicated by the position of the sub-mirror bolder 504. It should be noted that the main-mirror holder 502 includirm the main mirror 501 is prescribed as a “main mirror unit (first mirror unit)”. Similarly, the sub-mirror holder 504 including the sub mirror 503 is prescribed as a “sub mirror unit (second mirror unit)”. Then, a unit including the main mirror unit and the sub mirror unit is prescribed as a “mirror drive unit 500”. The positions of the main-mirror holder 502 in the mirror-down state and the mirror-up state are referred to as a “first position” and a “second position”, respectively. The positions of the sub-mirror holder 504 in the mirror-down state and the mirror-up state are referred to as a “third position” and a “fourth position” respectively.

The mirror drive unit 500 is driven by a mirror charging unit 600 (see FIG. 3), and the mirror drive unit 500 rotates between the mirror-down state shown in FIG. 2A and the mirror-up state shown in FIG. 21B. When the mirror drive unit 500 enters into the photographing light path and is in the mirror-down state, a part of the object light beam passing through the photographing lens 200 is reflected by the main mirror 501, and the other part is transmitted through the main mirror 501 and, is reflected by the sub mirror 503. The object light beamr reflected by the main mirror 501 is guided to the pentagonal prism 22 of the finder optical system 4. The object light beam reflected by the sub mirror 503 is guided to the focus detection unit 31. When the mirror drive unit 500 is retracted from the photographing light path and is in the mirror-up state, the object light beam passing through the photographing lens 200 forms an image on the image pickup device 33.

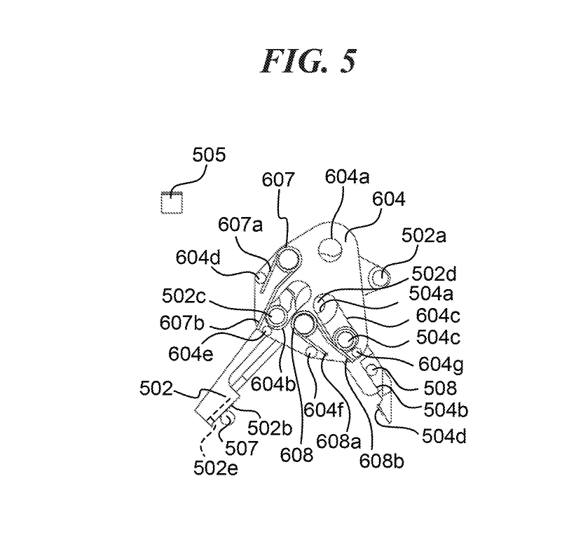

FIG. 3 is an exploded perspective view of a mirror drive device 1000. The mirror drive device 1000 has the mirror box 400, mirror drive unit 500, and mirror charging unit 600. A rotating shaft 502a used as a rotation center is formed in the main-mirror holder 502, and the rotating shaft 502a is rotatably supported by the mirror box 400. A support hole 504a is formed in the sub-mirror holder 504, and the support hole 504a is rotatably supported by a rotating shaft 502d of the main-mirror holder 502 (see FIG. 5). Thereby, the sub-mirror holder 504 becomes rotatable around the rotating shaft 502d with respect to the main-mirror holder 502.

The mirror box 400 is provided with a stopper 505 to which the front end of the main-mirror holder 502 contacts when the main-mirror holder 502 rotates to the mirror-up state. The stopper 505 is formed by an elastic member that absorbs a shock of the contact of the main-mirror bolder 502. A shaft pressing plate 506 that presses the rotating shaft 502a of the main-mirror holder 502 is attached to the back side of the mirror box 400. Thereby, the main-mirror holder 502 is rotatably attached to the mirror box 400 without dropping out.

The mirror charging unit 600 is attached to the right side of the mirror box 400 when the image pickup device is viewed from the object side along with the optical axis direction. The mirror charging unit 600 has the motor 601 and a drive lever unit 700. The drive lever unit 700 <has a drive lever 604, spring 607, and spring 608. The drive lever 604 is a drive member that drives the main mirror unit and sub mirror unit (details will be mentioned later), and is rotatable with respect to the mirror box 400 around a support hole 604a. The motor 601 is directly linked with the support hole 604a of the drive lever 604. The drive lever 604 is rotated by driving the motor 601. It should be noted that the direct linkage between the motor 601 and the drive lever 604 is not necessarily needed. They may be linked through a gear etc. The motor 601 is a stepping motor, for example, The motor 601 is an example of an actuator that rotates the drive lever 604, and another actuator may be used in place of the motor 601. The mirror drive circuit 101 counts the number of pulses supplied to the motor 601 from start of driving of the mirror drive emit 500, and the MPU 100 grasps the phase of the mirror drive unit 500 through the mirror drive circuit 101.

The spring 607 is a torsion spring. One end 607a of the spring 607 is locked by a first spring-locking part 604d (see FIG. 5) of the drive lever 604. In the meantime, a drive dowel 502e and a down-position contact part 502b are formed in the main-mirror holder 502. Although details will be mentioned later, the drive dowel 502c is a first driven part that is inserted into a main-mirror drive part 603b formed in the drive lever 604 and is driven by the main-mirror drive part 604b. When the mirror drive unit 500 is in the mirror-down state, the other end 607b of the spring 607 is in contact with the drive dowel 502c. Thereby, the main-mirror holder 502 is energized in a mirror-down direction by the spring 607, and the condition where the down-position contact part 502b is in contact with a positioning dowel 507 is maintained (see FIG. 5). The positioning dowel 507 is constituted by an eccentric pin etc., and is a first positioning member that enables adjustment of the position of the main-mirror holder 502 in the mirror-down a state by rotating the positioning dowel 507 to change the contact position with respect to the main-mirror holder 502.

The spring 608 is a torsion spring. One end 608a of the spring 608 is locked by a third spring-locking part 604f (see FIG. 5) of the drive lever 604. In the meantime, a drive dowel 504c and a down-position contact part 504b are formed in the sub-mirror holder 504. Although details will be mentioned later, the drive dowel 504c is a second driven part that is inserted into a sub-mirror drive part 604c formed in the drive lever 604 arid is driven by the sub-mirror drive part 604c. When the mirror drive unit 500 is in the mirror-down state, the other end 608b of the spring 608 is in contact with the drive dowel 504c. Thereby the sub-mirror holder 504 is energized in the mirror-down direction by the spring 608, and the condition where the down-position contact part 504b is in contact with a positioning dowel 508 is maintained (see FIG. 5). The positioning dowel 508 is constituted by an eccentric pin etc., and is a second positioning member that enables adjustment of the position of the sub-mirror holder 504 in the mirror-down state by rotating the positioning dowel 508 to change the contact position with respect to the sub-mirror holder 504.

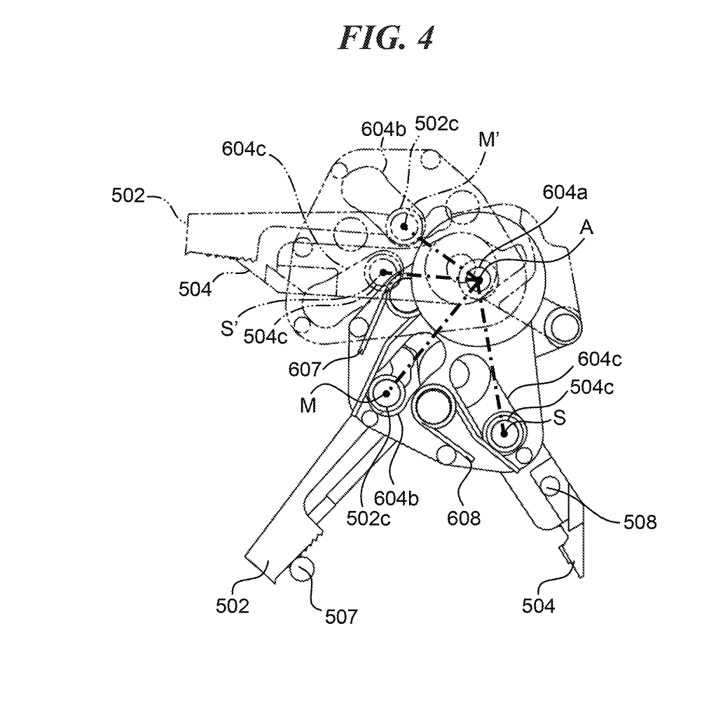

FIG. 4 is a view for describing relation between the mirror drive unit 500 and the drive lever unit 700. In FIG. 4, the mirror drive unit 500 in the mirror-up state is indicated by solid lines, and the mirror drive unit 500 in the mirror-down state is indicated by two-dot chain lines. In the following description, the position of the drive lever 604 at the time when the mirror drive unit 500 is in the mirror-down state is referred to as a “down-holding position (fifth position)”. Moreover, the position of the drive lever 604 in the case where the mirror drive unit 500 is in the mirror-up state is referred to as an “up-holding position (sixth position)”.

The position of the support hole 604a that is a rotation center of the drive lever 604 shall be indicated by “A”. The position of the drive dowel 502c in the case where the main-mirror holder 502 is in the mirror-down state shall be indicated by “M”. The position of the drive dowel 502c in the case where the main-mirror holder 502 is in the mirror-up state shall be indicated by “M”. Furthermore, the position of the drive dowel 504c in the case where the sub-mirror holder 504 is in the mirror-down state shall be indicated by “S”. The position of the drive, dowel 504c in the case where the sub-mirror holder 504 is in the mirror-up state shall be indicated “S”. A rotation angle of the drive lever 604 while moving between the down-holding position and the up-holding position shall be indicated by “θ”.

An angle that is formed by a line connecting the points M and A and a line connecting the points A and S shall be indicated by an “angle MAS”. An angle that is formed by a line connecting the points M′ and A and a line connecting the points A and S′ shall be indicated by an “angle M′AS′”. The following relation holds.

MAS≈M′AS′+(SAS′−θ)−(MAM′−θ)

The angle SAS′ is formed by the line connecting the points S and A and the line connecting the points A and S′. The angle SAS′ indicates a rotation angle of the drive dowel 504c rotating around the support hole 604a during the movement of the sub-mirror holder 504 between the mirror-down state and the rnirror-up state. An angle MAM′ is formed by the line connecting the points M and A and the line connecting the point A and M′. The angle MAM′ indicates a rotation angle of the drive dowel 502c rotating around the support hole 604a during the movement of the main-mirror holder 502 between the mirror-down state and the mirror-up slate. The above-mentioned relation shows that the main-mirror holder 502 and the sub-mirror holder 504 are able to move between the mirror-down state and the mirror-up state during the movement of the drive lever 604 between the dow n-holding position and the up-holding position.

The drive lever 604 has the main-mirror drive part 604b as a first contact part that transmits power during inirror-up driving and mirror-down driving by contacting the drive dowel 502c of the main-mirror holder 502. The main-mirror drive part 604b has a groove shape that connects an area facing the drive dowel 502c at the down-holding position and an area facing the drive dowel 502c at the up-holding position. As mentioned later, the main-mirror drive part 604b is shaped so that the main-mirror drive part 604b can contact the drive dowel 502c during the mirror-up driving and the mirror-down driving but does not contact the drive dowel 502c in the mirror up state and the mirror down state.

Moreover, the drive lever 604 has the sub-mirror drive part 604c as a second contact part that transmits power during the mirror-up driving and the mirror-down driving by contacting the drive dowel 504c of the sub-mirror holder 504. The sub-mirror drive part 604c has a groove shape that connects an area facing the drive dowel 504c at the down-holding position and an area facing the drive dowel 504c at the up-holding position. The sub-mirror drive part 604c is shaped so that the sub-mirror drive part 604e can contact the drive dowel 504c during the mirror-up driving, the mirror-down driving, and;in the mirror up state but does not contact the drive dowel 504c in the mirror down state.

When the mirror drive device 1000 performs the mirror-up action, the drive lever 604 rotates from the down-holding position toward the up-holding position in the mirror-up direction (clockwise in FIG. 4) because the motor 601 rotates in the mirror-up direction (clockwise in FIG. 4). The main-mirror holder 502 performs the mirror-up action because the drive dowel 502c contacts the main-mirror drive part 604b of the drive lever 604. At this time, the sub-mirror holder 504, performs the mirror-up action because the drive dowel 504c contacts the sub-mirror drive part 604c of the drive lever 604.

When the mirror drive device 1000 performs the mirror-down action, the drive lever 604 rotates from the up-holding position toward the down-holding position in the mirror-down direction (counterclockwise in FIG. 4) because the motor 601 rotates in the mirror-down direction (counterclockwise in FIG. 4). The main-mirror holder 502 performs the mirror-down action because the drive dowel 502c contacts the main-mirror drive part 604b of the drive lever 604. At this time, the sub-mirror holder 504 performs the mirror-down action because the drive dowel 504c contacts the sub-mirror drive part 604c of the drive lever 604.

Next, the mirror-up action and the mirror-down action of the mirror drive unit 500 in the mirror drive device 1000 will be described by referring to FIG. 5 through FIG. 8B. It should be noted that FIG. 5 through FIG. 8B are side views showing the mirror drive unit 500, stopper 505 positioning dowel 507, positioning dowel 508, and drive lever unit 700 in a direction from the right side to the left side when the image pickup device is viewed from the object side.

FIG. 5 is a view for describing a condition of the respective parts in the case vhere the mirror drive unit 500 is in the mirror-down state. When the mirror drive unit 500 is in the mirror-down state, the drive lever 604 is located at the down-holding position as mentioned above.

Under the condition shown in FIG. 5 the one end 607a of the spring 607 is locked by the first spring-locking part 604d of the drive lever 604, and the other end 607b of the spring 607 energizes the drive dowel 502c of the main-mirror holder 502 in the mirror-down direction. Thereby, the down-position contact part 502b of the main-mirror holder 502 is in contact with the positioning dowel 507. A width of an area within the main-mirror drive part 604b that faces the drive dowel 502c in the rotational direction of the main-mirror holder 502 in a case where the drive lever 604 is located at the down-holding position is wider than a width of an area that contacts the drive dowel 502c during the mirror driving. According, the main-mirror drive part 604b does not contact the drive dowel 502c in the case where the drive lever 604 is located at the down-holding position.

Moreover, the one end 608a of the spring 608 is locked by the third spring-locking part 604f of the drive lever 604, and the other end 608b of the spring 608 energizes the drive dowel 504c of the sub-mirror holder 504 in the mirror-down direction. Thereby, the down-position contact part 504b of the sub-mirror holder 50 is in contact with the positioning dowel 508. A width of an area within the sub-mirror drive part 604c that faces the drive dowel 504c in the rotational direction of the sub-mirror holder 504 in the case where the drive lever 604 is located at the down-holding position is wider than a width of an area that contacts the drive dowel 504c during the mirror driving. Accordingly, the sub-mirror drive part 604c does not contact the drive dowel 504c in the case where the drive lever 604 is located at the down-holding position.

In this way, since the main-mirror holder 502 and the sub-mirror holder 504 are positioned by respectively contacting the positioning dowels 507 and 508, they are stably held at the positions in the mirror-down state. Although the drive lever unit 700 receives energization force in the mirror-up direction by the reaction forces of the springs 607 and 608, the rotation of the drive lever unit 700 in the mirror-up direction is suppressed by the holding force of the motor 601, etc.

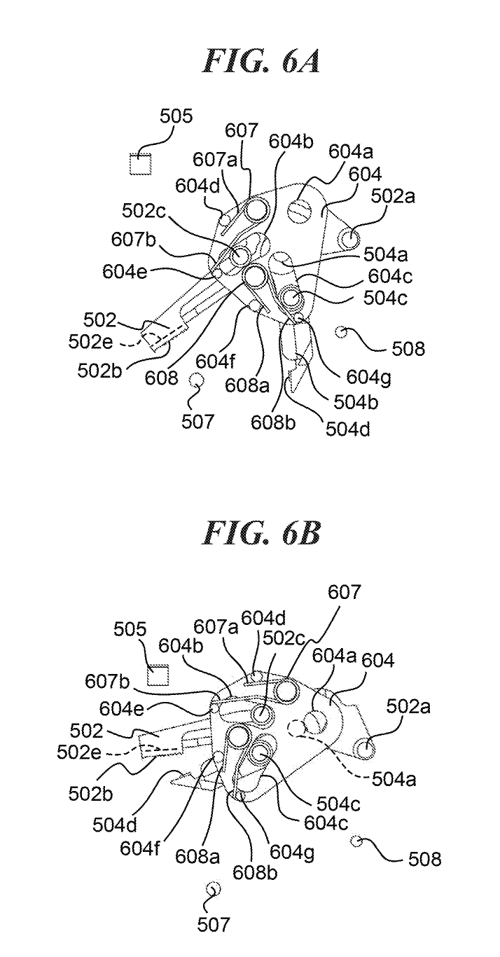

When the motor 601 is driven in order to perform the mirror-up action of the mirror drive unit 500 in the mirror-down state, the mirror drive unit 500 etc. change to the condition shown in FIG. 6A from the condition shown in FIG. 5. FIG. 6A is a view for describing the condition of the respective parts at the timing immediately after starting the mirror-up action of the mirror drive unit 500.

Under the condition shown in FIG. 6A, the drive lever 604 rotates in the mirror-up direction, and the drive dowel 502c of the main-mirror holder 502 contacts the mirror-down-side face of the main-mirror drive part 604b. Accordingly, the main-mirror holder 502 rotates in the mirror-up direction. At this time, the one end 607a of the spring 607 is locked by the first spring-locking part 604d of the drive lever 604, and the other end 607b contacts a second spring-locking part 604e of the drive leer 604 and does not contact the drive dowel 502c of the main-mirror holder 502 thereby.

Moreover, the drive dowel 504c of the sub-mirror holder 504 contacts the mirror-down-side face of the sub-mirror drive part 604c of the drive lever 604, and the sub-mirror holder 504 rotates in the direction (mirror-up direction) closing with respect to the main-mirror holder 502. At this time, the one end 608a of the spring 608 is locked by the third spring-locking part 604f of the drive lever 604, and the other end 608b contacts a fourth spring-locking part 604g of the drive lever 604 and does not contact the drive dowel 504c of the sub-mirror holder 504 thereby.

When the mirror-up action progresses from the condition shown in FIG. 6A, the condition shown in FIG. 6B appears. FIG. 6B is a view for describing the condition of the respective parts at the timing Immediately before completing the mirror-up action of the mirror drive unit 500.

FIG. 6B shows the condition where the mirror drive unit 500 tends to rotate preceding the drive lever 604 in the mirror-up direction because a rotational speed of the drive lever 604 becomes slower by deceleration control of the motor 601. At this time, the drive dowel 502c of the main-mirror holder 502 contacts the mirror-up-side face of the main-mirror drive part 604b of the drive lever 604, and thereby, the main-mirror holder 502 rotates in the mirror-up direction while reducing the speed. Moreover, at this time, the one end 607a of the spring 607 contacts the first spring-locking part 604d of the drive lever 604, and the other end 607b contacts the second spring-locking part 604e of the drive lever 604 and is not in contact with the drive dowel 502c of the main-mirror holder 502 thereby.

Under the condition shown in FIG. 6B, the drive dowel 504c of the sub-mirror holder 504 contacts the mirror-up-side face of the sub-mirror drive part 604c of the drive lever 604. Thereby, the sub-mirror holder 504 rotates in the direction (mirror-up direction) closing with respect to the main-mirror holder 502 while reducing the speed. Moreover, at this time, the one end 608a of the spring 608 contacts the third spring-locking part 504f of the drive lever 604, and the other end 608b contacts the fourth spring-locking part 604g of the drive lever 604 and is not in contact with the drive dowel 504c of the sub-mirror holder 504 thereby.

Thus, the speeds of the main-mirror holder 502 and the sub-mirror holder 504 are reduced by decelerating the drive lever 604 dtie to the deceleration control of the motor 601 immediately'before the arrival of the mirror drive unit 500 at the mirror-up state. This reduces the shock caused by colliding the main-mirror holder 502 against the stopper 505 and reduces the shock caused by colliding a second contact part 504d at the front end of the sub-mirror holder 504 against a second contact part 502e at the front end of the main-mirror holder 502.

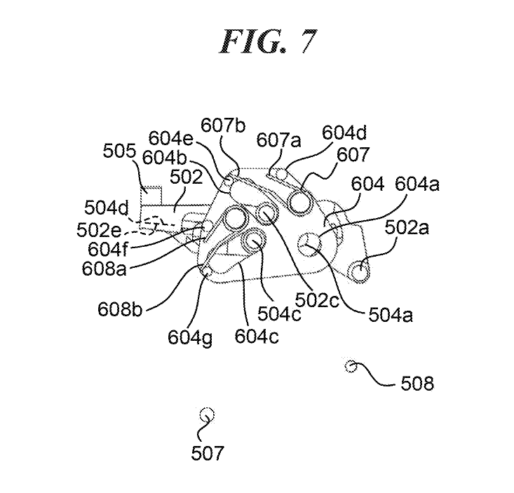

When the mirror-up action progresses from the condition shown in FIG. 6B, the condition shown in FIG. 7 appears. FIG. 7 is a view for describing a condition of the respective parts in the case where the mirror drive unit 500 is in the mirror-up state. When the mirror drive unit 500 is in the mirror-down state, the drive lever 604 is located at the up-holding position as mentioned above.

Under the condition shown in FIG. 7, the sub-mirror drive part 604c of the drive lever 604 contacts the drive dowel 504c of the sub-mirror holder 504, and the second contact part 504d at the front end of the sub-mirror holder 504 contacts the second contact part 502e at the front end of the main-mirror holder 502. A width of an area within the main-mirror dine part 604b that faces the drive dowel 502c in the rotational direction of the main-mirror holder 502 in a case where the drive lever 504 is located at the up-holding positicm is wider than a width of an area that contacts the drive dowel 502c during the mirror driving. Accordingly, the main-mirror drive part 604b does not contact the drive dowel 502c in the case xvbere the drive lever 604 is located at the up-holding position.

Moreover, the front end of the main-mirror bolder 502 contacts the stopper 505 while elastically deforming the stopper 505, and the second contact part 504d at the front end of the sub-mirror holder 504 is in contact with the second contact part 502e at the front end of the main-mirror holder 502. That is, when the main-mirror holder 502 is in the mirror-up state, the front end of the main-mirror holder 502 is interposed between the sub-mirror holder 504 and the stopper 505. Thus, since the front ends of the main-mirror holder 502 and the sub-mirror holder 504 are closed, a light beam entered from the finder optical system 4 is prevented from entering inside the mirror box 400.

When the mirror drive unit 500 is in the mirror-up state, the drive lever unit 700 receives energization force in the mirror-down direction because the main-mirror holder 502 receives energization force in the mirror-down direction by the reaction force of the stopper 505. However, the rotation of the drive lever unit 700 in the mirror-down direction is regulated by the holding force of the motor 601, etc.

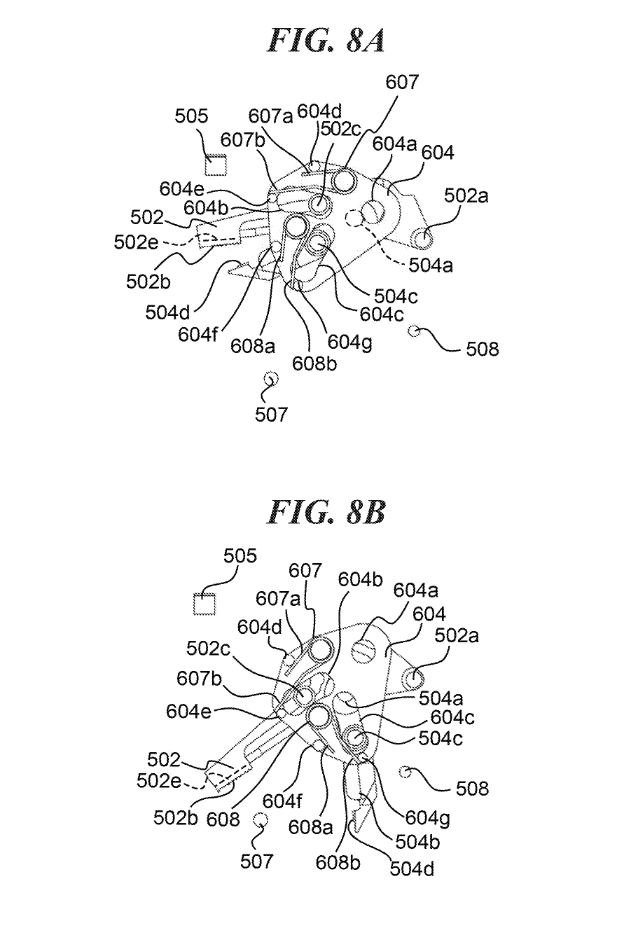

When the motor 601 is driven in order to perform the mirror-down action of the mirror drive unit 500 in the mirror-down state, the mirror drive unit 500 etc. change to the condition shown in FIG. 5A from the condition shown in FIG. 7. FIG. 8A is a view for describing the condition of the respective parts at the timing after starting the mirror-down action of the mirror drive unit 500.

Under the condition shown in FIG. 8A, the drive lever 604 has rotated in the mirror-down direction, and the drive dowel 502c of the main-mirror holder 502 is in contact with the mirror-up-side face of the main-mirror drive part 604b of the drive lever 604. Accordingly, the main-mirror holder 502 rotates in the mirror-down direction. At this time, the one end 607a of the spring 607 is locked by the first spring-locking part 604d of the drive lever 604, and the other end 607b contacts the second spring-locking part 604e of the drive lever 604 and does not contact the drive dowel 502c of the main-mirror holder 502 thereby. Moreover, the drive dowel 504c of the sub-mirror holder 504 is in contact with the mirror-up-side face of the sub-mirror drive part 604c of the drive lever 604, and the sub-mirror holder 504 rotates in a direction (mirror-down direction) opening with respect to the main-mirror holder 502. At this time, the one end 608a of the sprina 608 contacts the third spring-locking part 604f of the drive lever 604, and the other end 608f contacts the fourth spring-locking part 604g of the drive lever 604 and does not contact the drive dowel 504c of the sub-mirror holder 504 thereby.

When the mirror-down action progresses from the condition shown in FIG. 8A, the condition shown in FIG. 8B appears. FIG. 8B is a view for describing the condition of the respective parts at the timing immediately before completing the mirror-down action of the mirror drive unit 500.

FIG. 8B shows the condition where the mirror drive unit 500 tends to rotate preceding the drive lever 604 in the mirror-down direction because a rotational speed of the drive lever 604 becomes slower by deceleration control of the motor 601. At this time, the drive dowel 502c of the main-mirror holder 502 contacts the mirror-down-side face of the main-mirror drive part 604b of the drive lever 604, and thereby, the main-mirror holder 502 rotates in the mirror-down direction while reducing the speed. Moreover, at this time, the one end 607a of the spring 607 contacts the first spring-locking part 604d of the drive lever 604, and the other end 607b contacts the second spring-locking part 604e of the drive lever 604 and is not in contact with the drive dowel 502c of the main-mirror holder 502 thereby.

Under the condition shown in FIG. 8B, the drive dowel 504c of the sub-mirror holder 504 contacts the mirror-down-side face of the sub-mirror drive part 604c of the drive lever 604. Thereby, the sub-mirror holder 504 rotates in the direction (mirror-down direction) opening with respect to the main-mirror holder 502 vibile reducing the speed. Moreover, at this time, the one end 608a of the spring 608 contacts the third spring-locking part 604f of the drive lever 604, and the other end 608b contacts the fourth spring-locking part 604g of the drive lever 604 and is not in contact with the drive dowel 504c of the sub-mirror holder 504 thereby.

Thus, the speed of the main-mirror holder 502 and the sub-mirror holder 504 are reduced by decelerating the drive lever 604 due to the deceleration control of the motor 601 immediately before the arrival of the mirror drive unit 500 at the mirror-down state. This reduces the shock caused by colliding the main-mirror holder 502 against the positioning dowel 507 and reduces the shock caused by colliding the sub-mirror holder 504 against the positioning dowel 508. When the mirror-down action of the mirror drive unit 500 further progresses from the condition shown in FIG. 8B noted that FIG. 8B, the mirror drive unit 500 will be in the mirror down state shown in FIG. 5.

As described above, in a first embodiment, the rotations of the main-mirror holder 502 and the sub-mirror holder 504 are restricted by the drive lever 604. The rotational speeds of the main-mirror holder 502 and the sub-mirror holder 504 in the mirror-up action and the mirror-down action are controlled by controlling the rotational speed of the motor 601 connected with the drive le ver 604. This reduces the shocks that are received by the mirror drive unit 500 when the mirror-up action and the mirror-down action of the mirror drive unit 500 are completed, reduces the mirror bounds, and reduces mirror driving noise.

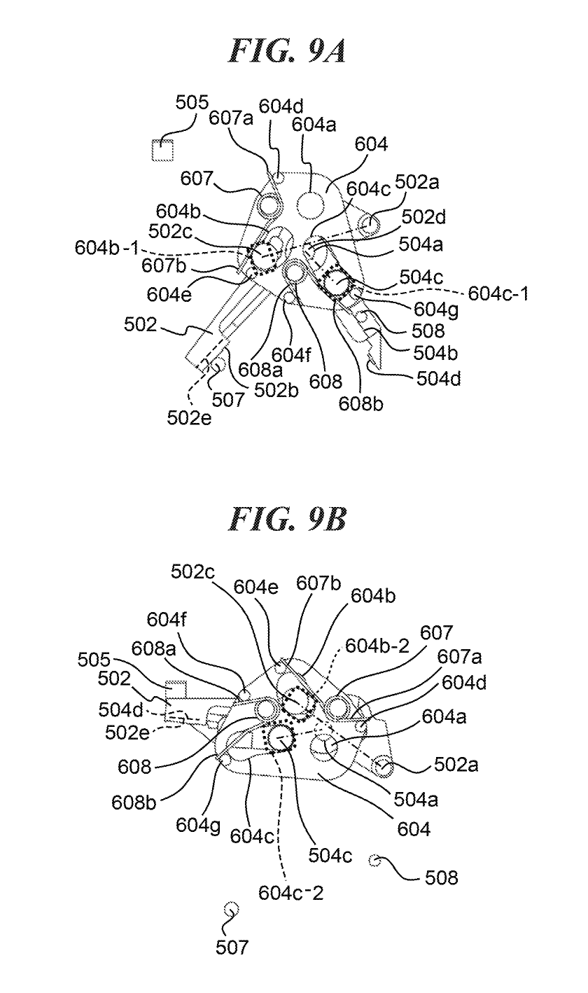

Next, a second embodiment of the present invention will be described. Among components of the mirror drive device according to the second embodiment, equivalent parts and parts having equivalent functions to the components of the mirror drive device 1000 according to the first embodiment shall be indicated by the same reference numerals in FIG. 9A and FIG. 9B referred. Descriptions about the mirror drive device according to the second embodiment that are common to that of the mirror drive device 1000 according to the first embodiment are omitted.

FIG. 9A is a view showirw a condition where the mirror drive unit according to the second embodiment is in the mirror-down state as with FIG. 5. In this condition, the one end 607a of the spring 607 is locked by the first spring-locking part 604d of the drive lever 604 and the other end 607b energizes the drive dowel 502c of the main-mirror holder 502 in the mirror-down direction. Thereby, the down-position contact part 502b of the main-mirror holder 502 contacts the positioning dowel 507. At this time, the main-mirror drive part 604b of the drive lever 604 is not in contact with the drive dowel 502c.

The main-mirror drive part 604b of the drive lever 604 has a first area 604b-1 that faces the drive dowel 502c of the main-mirror holder 502 in the case where the drive lever 604 is located at the down-holding position. A mirror-dowm side and mirror-up side of the first area 604b-1 are approximately parallel to a straight line that connects the center of the rotating shaft 502a of the main-mirror holder 502 and the center of the drive dowel 502c at the down-holding position. This minimizes a gap between the main-mirror drive part 604b and the drive dowel 502c in a case where the drive lever 604 is located at the down-holding position and its near position. As a result, since the rotation of the main-mirror holder 502 around the rotating shaft 502a is suppressed, the mirror-down bound is reduced.

Moreover, the one end 608a of the spring 608 is locked by the third spring-locking part 604f of the drive lever 604, and the other end 608b energizes the drive dowel 504c of the sub-mirror holder 504 in the mirror-down direction. Thereby, the down-position contact part 504b of the sub-mirror holder 504 contacts the positioning dowel 508. At this time, the sub-mirror drive part 604c of the drive lever 604 is not in contact with the drive dowel 504c.

The sub-mirror drive part 604c of the drive lever 604 has, a third area 604c-1 that faces the drive dowel 504c of the sub-mirror holder 504 in the case where the drive lever 604 is located at the down-holding position. A mirror-down side and mirror-up side of the third area 604c-1 are approximately parallel to a straight line that connects the center of the support hole 504a of the sub-mirror holder 504 and the center of the drive dowel 504c at the down-holding position. This mininnzes a gap between the sub-mirror drive part 604c and the drive dowel 504c in the case where the drive lever 604 is located at the down-holding position and its near position. As a result, since the rotation of the sub-mirror holder 504 around the support hole 504a is suppressed, the mirror-down hound is reduced.

FIG. 9B is a view for describing a condition of the respective parts in the case where the mirror drive unit 500 is in the mirror state, and the parts are shown as with FIG. 7. Under this condition, the sub-mirror drive part 604c of the drive lever 604 contacts the drive dowel 504c of the sub-mirror holder 504, and the second contact part 504d at the front end of the sub-mirror holder 504 is in contact with the second contact part 502e at the front end of the main-mirror holder 502. Moreover, the front end of the main-mirror holder 502 is in contact with the stopper 505 while elastically deforming the stopper 505.

At this time, the drive dowel 502c of the main-mirror holder 502 is not in contact with the main-mirror drive part 604b of the drive lever 604. The main-mirror drive part 604b of the drive lever 604 has a second area 604b-2 that faces the drive dowel 502c of the main-mirror holder 502 in the case here the drive lever 604 is located at the up-holding position. A mirror-down side and mirror-up side of the second area 604b-2 are approximately parallel to the straight line that connects the center of the rotating shaft 502a of the main-mirror holder 502 and the center of the drive dowel 502c at the up-holding position. This minimizes a gap between thelain-mirror chive part 604b and the drive dowel 502c in a case where the drive lever 604 is located at the up-holding position and its near position. As a result, since the rotation of the main-mirror holder 502 around the rotating shaft 502a is suppressed, the mirror-up bound is reduced.

Moreover, the sub-mirror drive part 604c of the drive lever 604 has a fourth area 604c-2 that faces the drive dowel 504c of the sub-mirror holder 504 in the case where the drive lever 604 is located at the up-holding position. A mirror-down side and mirror-up side of the fourth area 604c-2 are approximately parallel to the straight line that connects the center of the support hole 504a of the sub-mirror holder 504 and the center of the drive dowel 504c at the up-holding position. This minimizes a gap between the sub-mirror drive part 604c and the drive dowel 504c in the case where the drive lever 604 is located at the up-holding position and its near position. As a result, since the rotation of the sub-mirror holder 504 around the support hole 504a is suppressed, the mirror-down bound is reduced.

As described above the drive lever 604 restricts the rotations of the main-mirror holder 502 and the sub-mirror holder 504 in the cases where the drive lever 604 is positioned at the down-holding position the up-holding position, and their near positions in the second embodiment. Accordingly, the generation the mirror-down bound and the mirror-up bound can further be suppressed.

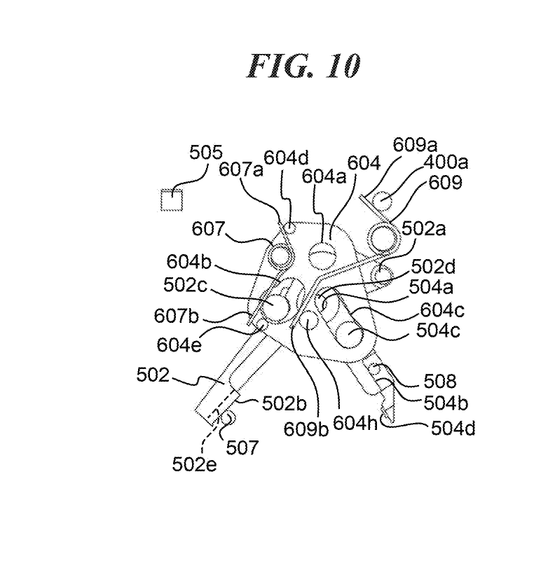

Next, a third embodiment of the present invention will be described. Among components of the mirror device according to the third embodment, equivalent parts and parts having equivalent functions to the components of the mirror drive device 1000 according to the first embodiment shall be indicated by the same reference numerals in FIG. 10 referred. Descriptionsabout the mirror drive device according to the third embodiment that are common to that of the mirror drive device 1000 according to the first embodiment are omitted.

FIG. 10 is a view showing a condition where the mirror drive unit according to the third embodiment is in the mirror-down state as with FIG. 5. Although the mirror drive device according to the third embodiment is not provided with the spring 608 of the mirror drive device 1000 according to the first embodiment, a drive-lever spring 609 is provided. In connection with this, a fifth spring-locking part 604h is provided in the drive lever 604. Under the condition shown in FIG. 10, one end 609a of the drive-lever spring 609 is locked by a spring locking part 400a provided in the mirror box 400, and the other end 609b contacts the fifth spring-locking part 604h and energizes the drive lever 604 in the mirror-down direction. That is, the drive-lever spring 609 is an energizing member that energizes the drive lever 604 so as to hold the drive lever 604 at the down-holding position. Moreover, the one end 607a of the spring 607 is locked by the first spring-locking part 604d of the drive lever 604, and the other end 607b energizes the drive dowel 502c of the main-mirror holder 502 in the mirror-down direction. Thereby, the down-position contact part 502b of the main-mirror holder 502 contacts the positioning dowel 507. At this time, the main-mirror drive part 604b of the drive lever 604 is not in contact with the drive dowel 502c.

The configuration of the sub-mirror drive part 604c is the same as that of the second embodiment. Accordingly, under the condition shown in FIG. 10, the sub-mirror drive part 604c of the drive lever 604 contacts the drive dowel 504c of the sub-mirror holder 504, and energizes the sub-mirror holder 504 in the mirror-down direction. Thereby, the down-position contact part 504b of the sub-mirror holder 504 is in contact with the positioning dowel 508. Since the energization force in the mirror-down direction applied to the drive lever 604 by the drive-lever spring 609 is set to be larger than the energization force of the spring 607, the mirror drive unit is stabilized at the down-holding position.

As described above, when the mirror drive unit is in the mirror-down state, the sub-mirror drive part 604c of the drive lever 604 contacts the drive dowel 504c of the sub-mirror holder 504 in the third embodiment. Accordingly, the width of the sub-mirror drive part 604c can be narrowed. This enables reduction of the generation of the mirror-down bound because the speed of the sub-mirror holder 504 just before reaching the mirror-down state during the mirror-down action is controlled by the shape of the sub-mirror drive part 604c.

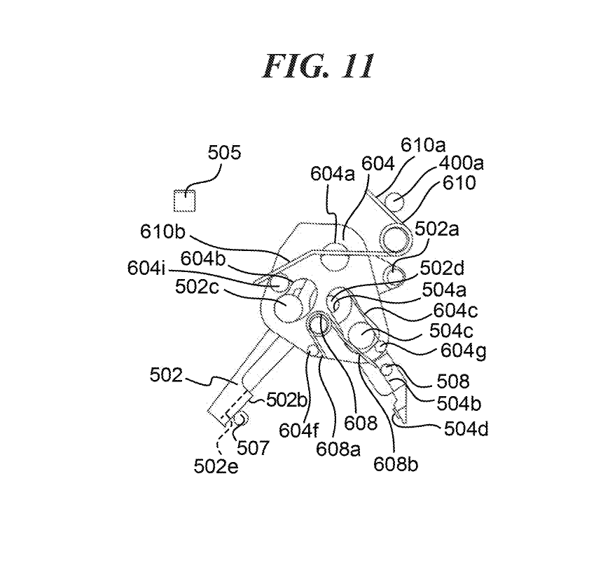

Next, a fourth embodiment of the present invention will be described. Among components of the mirror device according to the fourth embodiment, equivalent parts and parts having, equivalent functions to the components of the mirror drive device 1000 according to the first embodiment shall be indicated by the same reference numerals in FIG. 11 referred. Descriptions about the mirror drive device according to the fog ith embodiment that are common to that of the mirror drive device 1000 according, to the first embodiment are omitted.

FIG. 11 is a view showing a condition where the mirror drive unit according to the fourth embodiment is in the mirror-dowli state as with FIG. 5. Although the mirror drive device according to the fourth embodiment is not provided with the spring 607 of the mirror drive device 1000 according to the first embodiment, a drive-lever spring 610 is provided. In connection with this, a sixth spring-locking part 604i is provided in the drive lever 604. Under the condition shown in FIG. 10, one end 610a of the drive-lever spring 610 is locked by the spring locking part 400a provided in the mirror box 400, and the other end 610b contacts the sixth spring-locking part 604i and energizes the drive lever 604 in the mirror-down direction. Moreover, the one end 608a of the spring 608 is locked by the third spring-locking part 604f of the drive lever 604, and the other end 608b energizes the drive dowel 504c of the sub-mirror holder 504 in the mirror-down direction. Thereby, the down-position contact part 504b of the sub-mirror holder 504 contacts the positioning dowel 508. At this time, the sub-mirror drive part 604c of the drive lever 604 is not in contact with the drive dowel 504c.

The configuration of the main-mirror drive part 604b is the same as that of the second embodiment. Accordingly, under the condition shown in FIG. 11, the main-mirror drive part 604b of the drive lever 604 contacts the drive dowel 502c of the main-mirror holder 502, and energizes the main-mirror holder 502 in the mirror-down direction. Thereby, the down-position contact part 502b of the main-mirror holder 502 is in contact with the positioning dowel 507. Since the energization force in the mirror-down direction applied to the drive lever 604 by the drive-lever spring 610 is set to be larger than the energization force of the spring 608, the mirror drive unit is stabilized at the down-holding position.

As described above, when the mirror drive unit is in the mirror-down state, the main-mirror drive part 604b of the drive lever 604 contacts the drive dowel 502c of the main-mirror holder 502 in the fourth embodiment. Accordingly, the width of the main-mirror drive part 604b can be narrowed. This enables reduction of the generation of the mirror-down bound because the speed of the main-mirror holder 502 just before reaching the mirror-down state during the mirror-down action is controlled by the shape of the main-mirror drive part 604b.

Next, a fifth embodiment of the present invention will be described. Among components of die mirror device according to the fifth embodiment, equivalent parts and parts having equivalent functions to the components of the mirror drive device 1000 according to the first embodiment shall be indicated by the same reference numerals in FIG. 11 referred. Descriptions about the mirror drive device according to the fourth embodiment that are common to that of the mirror drive device 1000 according to the first embodiment are omitted.

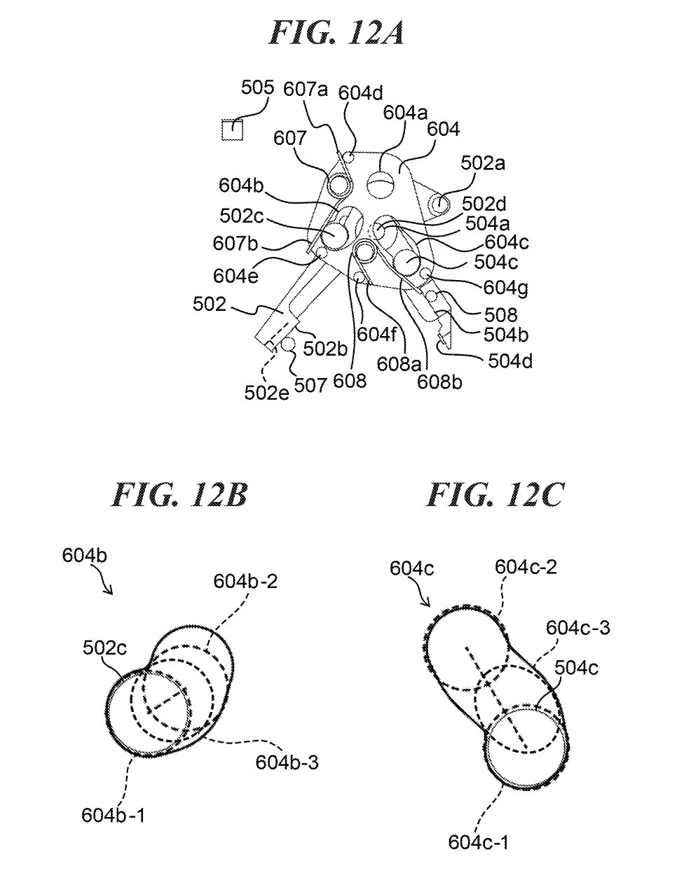

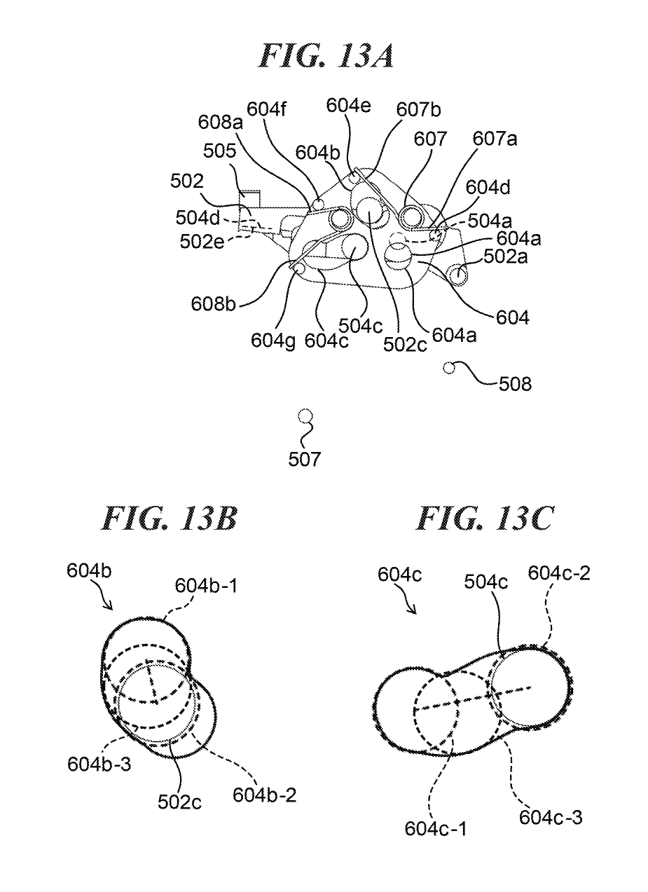

FIG. 12A is a view showing a condition where the mirror drive unit according to the fifth embodiment is in the mirror-down state as with FIG. 5. Under this condition, the main-mirror drive part 604b of the drive lever 604 and the drive dowel 502c of the main-mirror holder 502 arc not in contact with each other but are close as with the first embodiment (FIG. 5). Moreover, the sub-mirror drive part 604c of the drive lever 604 and the drive dowel 504c of the sub-mirror holder 504 are not in contact with each other but are close.

FIG. 13A is a view showing a condition where the mirror drive unit according to the fifth embodiment is in the mirror-down state as with FIG. 7. Under this condition, the main-mirror drive part 604b of the drive lever 604 is not in contact with the drive dowel 502c of the main-mirror holder 502. Moreover, the sub-mirror drive part 604c of the drive lever 604 is in contact with the drive dowel 504c of the sub-mirror holder 504.

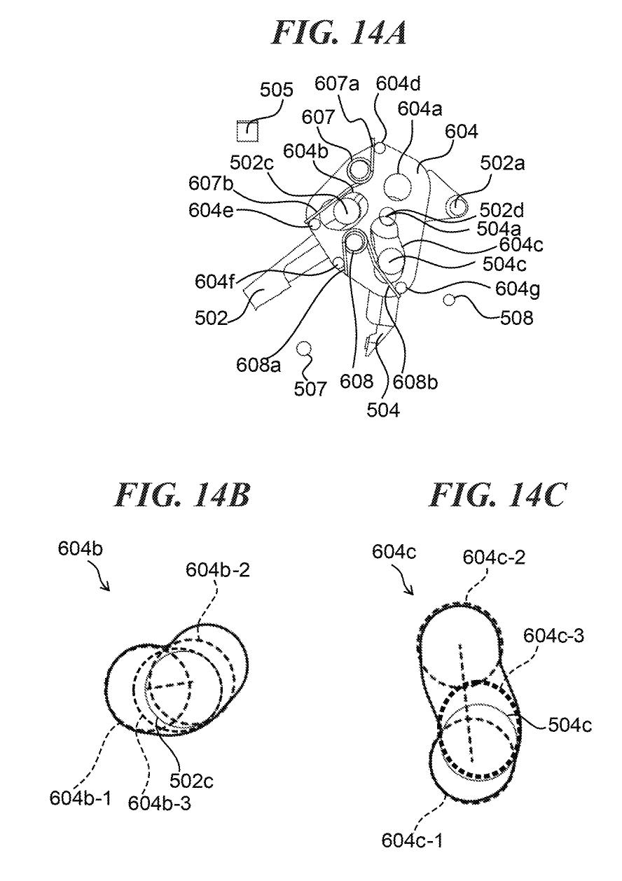

FIG. 14A is a view showing a condition where the mirror drive unit according to the fifth embodiment is in an intermediate state between the mirror-down state and the mirror-up state. Under this condition, the main-mirror drive part 604b of the drive lever 604 is in contact with the drive dowel 502c of the main-mirror holder 502 as with the first embodiment. Moreover, the sub-mirror drive part 604c of the drive lever 604 is in contact with the drive dowel 504c of the sub-mirror holder 504.

The fifth embodiment is characterized in the shapes of the main-mirror drive part 604b and the sub-mirror drive part 604c of the drive lever 604. FIG. 12B, FIG. 13B, and FIG. 14B are views for describing the relation between the main-mirror drive part 604b of the drive lever 604 and the drive dowel 502c of the main-mirror holder 502 in the respective conditions. FIG. 12C, FIG, 13C, and FIG. 14C are views for describing the relation between the sub-mirror drive part 604e of the drive lever 604 and the drive dowel 504c of the sub-mirror holder 504 in the respective conditions.

The main-mirror drive part 604b of the drive lever 604 has the first area 604b-1 that faces the drive dowel 502c of the main-mirror holder 502 as shown in FIG. 12B in the case where the drive lever 604 is located at the down-holding position. The main-mirror drive part 604b has the second area 604b-2 that faces the drive dowel 502c as shown in FIG. 13B in the case where the drive lever 604 is located at the up-holding position. The main-mirror drive part 604b has a fifth area 604b-3 that faces the drive dowel 502c as shown in FIG. 14B in a case where the drive lever 604 is located at an intermediate position between the up-holding position and the down-holding position. The fifth area 604b-3 is located closer to the sub-mirror holder 504 than a straight line that connects a center of the first area 604b-1 and a center of the second area 604b-2. That is, the main-mirror drive part 604b is so formed that the fifth area 604b-3 is protruded toward the sub-mirror holder 504.

The sub-mirror drive part 604c of the drive lever 604 has the third area 604c-1 that faces the drive dowel 504c of the sub-mirror holder 504 as shown in FIG. 12C in the case where the drive lever 604 is located at the down-holding position. The sub-mirror drive part 604c has the fourth area 604c-2 that faces the drive dowel 504c as shown in FIG. 13C in the case where the drive lever 604 is located at the up-holding position. The sub-mirror drive part 604c has a sixth area 604c-3 that faces the drive dowel 504c of the sub-mirror holder 504 as shown in FIG. 14C in the case where the drive lever 604 is located at the intermediate position. The sixth area 604c-3 is located at the side opposite to the main-mirror holder 502 than a straight line that connects a center of the third area 604c-1 and a center of the fourth area 604c-2. That is, the sub-mirror drive part 604c is formed so that the sixth area 604c-3 otruded toward the side opposite to the main-mirror holder 502.

As mentioned above, the rotation angle of the mirror drive unit with respect to the rotational speed becomes increasingly insensitive with approaching the mirror-down state due to the shapes of the main-mirror drive part 604b and sub-mirror drive part 604c the drive lever 604 in the fifth embodiment. That is, since the rotational speed of the mirror drive unit is reducible immediately before reaching the mirror-down state, the generation of the mirror-down bound is reduced.

Although the embodiments of the invention have been described, the present invention is not limited to the above mentioned embodiments, the present invention includes various modifications as long as the concept of the invention is not deviated. Furthermore, the embodiments mentioned above show examples of the present invention, and it is possible to combine the embodiments suitably.

### Other Embodiments

While the present invention has been described with reference to exemplary embodiments, it is to be understood that the invention is not limited to the disclosed exemplary embodiments. The scope of the folllowing claims is to be accorded the broadest interpretation so as to encompass all such modifications and equivalent structures and functions.

This application claim, the benefit of Japanese Patent Application No. 2018-072583, filed Apr. 4, 2018, which is hereby incorporated by reference herein in its entirety.

What is claimed is:

1. A mirror drive device comprising:
a first mirror unit that is rotatably attached to a mirror box and is movable between a first position within a photographing light path and a second position that is retracted from the photographing light path
a second mirror unit that is rotatably attached to the first mirror unit and is movable between a third position within the photographing light path and a fourth position that is retracted from the photographing light path; and
a drive member that is driven by an actuator so as to be movable between a fifth position and a sixth position,
wherein the drive member moves the first mirror unit to the second position from the first position and moves the second mirror unit to the fourth position from the third position when the drive member moves to the sixth position from the fifth position, and
wherein the drive member moves the first mirror unit to the first position from the second position and moves the second mirror unit to the third position from the fourth position when the drive member moves to the fifth position from the sixth position.

2. The mirror drive device according to claim 1, wherein the driving member comprises:
a first contact part that is able to contact the first mirror unit; and
a second contact pat t that i able to contact the second mirror unit,
wherein the first mirror unit has a first driven part that is able to contact the first contact part,
wherein the second mirror unit has a second driven part that is able to contact the second contact part,
wherein the first driven part contacts the first contact part during movement of the first mirror unit between the first position and the second position, and
wherein the second driven part contacts the second contact part during movement of the second mirror unit between the third position and the fourth position.

3. The mirror drive device according to claim 2, wherein the first contact part does not contact the first mirror unit in a case where the drive member is located in the fifth position.

4. The mirror drive device according to claim 2, wherein the second contact part does not contact the second mirror unit in a case where the drive member is located in the fifth position.

5. The mirror drive device according to claim 2, wherein the first contact part does not contact the first mirror unit in a case where the drive member is located in the sixth position.

6. The mirror drive device according to claim 2, wherein the drive member is rotatably driven by the actuator, and
wherein relation below holds:
MAS≈M′AS′+(SAS′−θ)−(MAM′−θ)
where
A: a rotation center of the drive member,
M: a position of the first driven part in a case where the first mirror unit is located in the first position,
M′: a position of the first driven part in a case where the first mirror unit is located in the second position,
S: a position of the second driven part in a case where the second mirror unit is located in the third position,
S′: a position of the second driven part in a case where the second mirror unit is located in the fourth position, and
θ: a rotation angle of the drive member while moving between the fifth position and the sixth position.

7. The mirror drive device according to claim 2, wherein a mirror-down side and a mirror-up side of a first area of the first contact part that faces the first driven part are approximately parallel to a straight line that connects a rotation center of the first mirror unit and the first driven part in a case where the first mirror unit is located in the first position and the drive member is located in the fifth position.

8. The mirror drive device according to claim 2, wherein a mirror-down side and a mirror-up side of a second area of the first contact part that faces the first driven part are approximately parallel to a straight line that connects a rotation center of the first mirror unit and the first driven part in a case where the first mirror unit is located in the second position and the drive member is located in the sixth position.

9. The mirror drive device according to claim 2, wherein a mirror-down side and a mirror-up side of a third area of the second contact part that faces the second driven part are approximately parallel to a straight line that connects a rotation center of the second mirror unit and the second driven part in a case where the second mirror unit is located in the third position and the drive member is located in the fifth position,

10. The mirror drive device according to claim 2, wherein a mirror-down side and a mirror-up side of a fourth area of the second contact part that faces the second driven part are approximately parallel to a straight line that connects a rotation center of the second mirror unit and the second driven part in a case where the second mirror unit is located in the fourth position and the drive member is located in the sixth position.

11. The mirror drive device according to claim 2, wherein the first driven part contacts the first contact part and the second driven part does not contact the second contact part in a case where the first mirror unit is located in the first position, the second mirror unit is located in the third position, and the drive member is located in the fifth position.

12. The mirror drive device according to claim 2, wherein the second driven part contacts the second contact part and the fist driven part does not contact the first contact part in a case where the first mirror unit is located in the first position, the second mirror unit is located in the third position, and the drive member is located in the fifth position.

13. The mirror drive device according to claim 2, wherein the first contact part comprises:
a first area that faces the first driven part in a case where the first mirror unit is located in the first position and the drive member is located in the fifth position;
a second area that faces the first driven part in a case where the first mirror unit is located in the second position and the drive member is located in the sixth position; and
a fifth area that contacts the first driven part during movement of the first mirror unit between the first position and the second position, and
wherein the fifth area is located closer to the second mirror unit than a straight line that connects a center of the first area and a center of the second area.

14. The mirror drive device according to claim 2, wherein the second contact part comprises:
a third area that faces the second driven part in a case where the second mirror unit is located in the third position and the drive member is located in the fifth position;
a fourth area that faces the second driven part in a case where the second mirror unit is located in the fourth position and the drive member is located in the sixth position; and
a sixth area that contacts the second driven part during movement of the second mirror unit between the third position and the fourth position, and wtherein the sixth area is located further from the first mirror unit than a straight line that connects a center of the third area and a center of the fourth area.

15. A mirror drive device according to claim 1, further comprising:
a first positioning member that contacts the first mirror unit and enables an adjustment of the first position;
a second positioning member that contacts the second mirror unit and enables an adjustment of the third position; and
an energizing member that energizes the drive member so as to hold at the fifth position, and
wherein the first mirror unit contacts the first positioning member and the second mirror unit contacts the second positioning member irrespective of adjustments by the first positioning member and the second positioning member in a case where the drive member is held in the fifth position by the energizing member.

16. An image pickup apparatus comprising:
a mirror box; and
a mirror drive device comprising:
a first mirror unit that is rotatably attached to the mirror box and is movable between a first position within a photographing light path and a second position that retracted from the photographing light path;
a second mirror unit that is rotatably attached to the first mirror unit and is movable between a third position within the photographing light path and a fourth position that is retracted from the photographing light path; and
a drive member that is driven by an actuator so as to be movable between a fifth position and a sixth position,
wherein the drive member moves the first mirror unit to the second position from the first position and moves the second mirror unit to the fourth position from the third position when the drive member moves to the sixth position from the fifth position, and
wherein the drive member moves the first mirror unit to the first position from the second position and moves the second mirror unit to the third position from the fourth position when the drive member moves to the fifth position from the sixth position.
